(19) United States
(12) Patent Application Publication
(10) Pub. No.: US 2025/0334686 A1
(43) Pub. Date: Oct. 30, 2025

(54) AUGMENTED REALITY LIVE SONAR

(71) Applicant: Navico Group Americas, LLC, Menomonee Falls, WI (US)

(72) Inventor: Andrew Chambers, Broken Arrow, OK (US)

(21) Appl. No.: 18/647,462

(22) Filed: Apr. 26, 2024

(51) Int. Cl. G01S 7/62; A01K 97/00; B63B 49/00; G01S 15/96

(52) U.S. Cl. CPC G01S 7/6245; A01K 97/00; B63B 49/00; G01S 7/6272; G01S 7/629; G01S 15/96

(57) ABSTRACT

An augmented reality system is provided including an augmented reality device comprising a display configured to allow a user to view a portion of a surrounding environment through the display. The portion of the surrounding environment corresponds to a current viewpoint of the user such that the user would otherwise see the portion if the device was not present. The system includes processor(s) and memory device(s) comprising computer program code configured, when executed by the processor(s), to cause the processor(s) to determine a position and line of sight of the device, receive a live sonar image, correlate the position and line of sight to a corresponding portion of the image, and cause presentation of the image on portion(s) of the display so that the portion of the surrounding environment and the corresponding portion of the image are both visible in the display from a user's perspective.

### FIELD OF THE INVENTION

Embodiments of the present invention relate generally to augmented reality devices for presenting a sonar image over a surrounding environment or along with a representation of the surrounding environment.

### BACKGROUND OF THE INVENTION

Currently, an angler must frequently look a display on his or her watercraft in order to determine where fish are located. Even once the angler obtains this information and processes it, fish are frequently moving targets, so the fish have likely moved away from the location identified on the display in the time it takes for the angler to move from the display to his or her fishing location and to cast. The angler is forced to remember where fish are located, and remembering the appropriate position relative to the forward direction of the watercraft can often be difficult. Even once the angler gets all of this information, the angler is often still left guessing where the fish is located based on that information.

The same issues are present for tracking other information. To navigate a watercraft, an operator is often required to review complex charts, maps, and other information. The process of analyzing this information to identify an appropriate target, pathway, etc. and then acting based on this information is often a tedious process that is potentially prone to a high amount of user error.

### BRIEF SUMMARY OF THE INVENTION

In various embodiments, live sonar images are presented on augmented reality devices so that the user may have visibility of the surrounding environment as well as live sonar images corresponding to the particular locations in the surrounding environment. Examples of augmented reality devices may include cell phones, smart phones, headsets, and smart glasses, but other augmented reality devices may be used as well. From the perspective of the user, the live sonar images may be superimposed on the surrounding environment, with the live sonar images being partially transparent so that the surrounding environment may also be seen.

As users look to different parts of the surrounding environment and rotate an augmented reality device, the positioning of the live sonar images may remain locked in place relative to the surrounding environment. Thus, locations within the live sonar images may continue to be positioned proximate to corresponding locations in the surrounding environment even after the augmented reality device is rotated.

The use of live sonar images may be beneficial to allow the user to see exactly where moving targets such as fish are located in the water. Thus, users (e.g., anglers) may keep their eyes on the water rather than looking to a display on the watercraft to get sonar information, allowing the users to make quick and effective decisions on where to cast. Targets may be emphasized on the display with various representations, and information may be provided about moving targets such as the target's speed, direction, type, position relative to watercraft, and size. Contour lines, hazards, recommended travel paths, and target locations may also be represented in the display.

In an example embodiment, an augmented reality system for use in a watercraft is provided. The augmented reality system includes an augmented reality device comprising a display configured to allow a user to view a portion of a surrounding environment through the display. The portion of the surrounding environment corresponds to a current viewpoint of the user such that the user would otherwise see the portion of the surrounding environment if the augmented reality device was not present. The augmented reality system also comprises one or more processors and one or more memory devices comprising computer program code. The computer program code is configured, when executed by the one or more processors, to cause the one or more processors to determine a position and a line of sight of the augmented reality device, receive a live sonar image, correlate the position and the line of sight of the augmented reality device to a corresponding portion of the live sonar image, and cause presentation of the live sonar image on at least one portion of the display so that the portion of the surrounding environment and the corresponding portion of the live sonar image are both visible in the display from a perspective of the user.

In some embodiments, the augmented reality device may be at least one of smart glasses or a headset, and the display may be provided in the form of lenses. Causing the live sonar image to be presented on at least one portion of the display of the augmented reality device may result in the live sonar image being shown in the lenses in a partially transparent manner so that both the portion of the surrounding environment and the corresponding portion of the live sonar image are visible.

In some embodiments, the augmented reality device may be a phone, a tablet, a computer, a headset, or a marine electronic device. The augmented reality device may comprise a screen and a camera, and the display may be the screen. The camera may be configured to generate one or more images of the portion of the surrounding environment. The one or more images of the portion of the surrounding environment may be presented on the screen alongside the live sonar image so that both the one or more images of the portion of the surrounding environment and the corresponding portion of the live sonar image are visible on the screen.

In some embodiments, the computer program code may be configured, when executed by the one or more processors, to cause the one or more processors to receive an identification of a target and cause a representation of the target to be highlighted. Additionally, in some embodiments, the augmented reality device may be configured to enable a selection or deselection of the target by a user by detecting a particular hand gesture in a particular direction, a voice command, a particular eye movement, or another head or body movement. Furthermore, in some embodiments, the target may be a moving target, and the representation of the target may remain highlighted as the target moves through the surrounding environment. In some embodiments, the moving target may be a fish or another underwater animal, and the computer program code may be configured, when executed by the one or more processors, to cause the one or more processors to overlay at least one of a movement speed or a direction vector for the moving target on the at least one portion of the display of the augmented reality device. Additionally, in some embodiments, the moving target may be a fish or another underwater animal, and the computer program code may be configured, when executed by the one or more processors, to cause the one or more processors to overlay identification information for the moving target on the at least one portion of the display of the augmented reality device. Also, in some embodiments, the moving target may be a fish or another underwater animal, and the computer program code may be configured, when executed by the one or more processors, to cause the one or more processors to determine a position on a water surface corresponding to a current location or an anticipated location for the moving target and overlay a target representation proximate to the position on the at least one portion of the display of the augmented reality device.

In some embodiments, the computer program code may be configured, when executed by the one or more processors, to cause the one or more processors to receive a user input that is at least one of a particular hand gesture, a voice command, an eye movement, a head movement, or a body movement. The computer program code may also be configured, when executed by the one or more processors, to adjust operation of a motor or a sonar transducer array based on the user input. The operation of the motor or the sonar transducer array may be adjusted by turning the motor or the sonar transducer array on or off, by changing an orientation of the motor or the sonar transducer array, or by changing a motor speed.

In some embodiments, the augmented reality system may also include a marine electronic device attached to the watercraft, and the augmented reality device may be configured to record a live video feed and send the live video feed to the marine electronic device or to the one or more memory devices.

In some embodiments, at least one of a travel path representation, a target location representation, a hazard representation, topographical representations indicating depth information, or a second image may be presented on the display, and the second image may be at least one of a sonar image, a radar image, an underwater image, or a video. Additionally, the second image may be presented on the display, and a particular position may be emphasized in both the second image and in the live sonar image.

In another example embodiment, an augmented reality device for use in a watercraft is provided. The augmented reality device includes a display configured to allow the user to view a portion of a surrounding environment through the display. The portion of the surrounding environment corresponds to a current viewpoint such that the user would otherwise see the portion of the surrounding environment if the augmented reality device was not present. The augmented reality device also includes one or more processors and one or more memory devices comprising computer program code. The computer program code is configured, when executed by the one or more processors, to cause the one or more processors to determine a position and a line of sight, receive a live sonar image, correlate the position and the line of sight to a corresponding portion of the live sonar image, and cause presentation of the live sonar image on at least one portion of the display so that the portion of the surrounding environment and the corresponding portion of the live sonar image are both visible in the display from a perspective of the user.

In some embodiments, the augmented reality device may be provided in the form of smart glasses and/or a headset, the display may be provided in the form of lenses, and causing the live sonar image to be presented in the display of the augmented reality device may result in the live sonar image being shown in the lenses in a partially transparent manner so that both the portion of the surrounding environment and the corresponding portion of the live sonar image are visible.

In some embodiments, the augmented reality device may be provided in the form of a phone, a tablet, a computer, a headset, or a marine electronic device, the augmented reality device may comprise a screen and a camera, and the display may be the screen. The camera may be configured to generate one or more images of the surrounding environment, and the one or more images of the surrounding environment may be presented on the screen alongside the live sonar image so that both the one or more images of the surrounding environment and the corresponding portion of the live sonar image are visible on the screen.

In another example embodiment, a method for using an augmented reality device is provided. The method includes determining a position and a line of sight of the augmented reality device, receiving a live sonar image, correlating the position and the line of sight of the augmented reality device to a corresponding portion of the live sonar image, and causing presentation of the live sonar image on at least one portion of the display so that the surrounding environment and the corresponding portion of the live sonar image are both visible in the display from a perspective of the user. In some embodiments, the method may also include receiving an identification of a target and causing a representation of the target to be highlighted.

In some embodiments, the augmented reality device may be provided in the form of at least one of smart glasses or a headset, the display may be provided in the form of lenses, and causing the live sonar image to be presented in the display of the augmented reality device may result in the live sonar image being shown in the lenses in a partially transparent manner so that both the portion of the surrounding environment and the corresponding portion of the live sonar image are visible.

In some embodiments, the augmented reality device may be provided in the form of a phone, a tablet, a computer, a headset, or a marine electronic device. The augmented reality device may comprise a screen and a camera, and the display may be the screen. The camera may be configured to generate one or more images of the surrounding environment, and the one or more images of the surrounding environment may be presented on the screen alongside the live sonar image so that both the one or more images of the surrounding environment and the corresponding portion of the live sonar image are visible on the screen.

### BRIEF DESCRIPTION OF THE DRAWINGS

Having thus described the invention in general terms, reference will now be made to the accompanying drawings, which are not necessarily drawn to scale, and wherein:

FIG. 1 is a schematic view illustrating an example watercraft including various marine devices, in accordance with some embodiments discussed herein;

FIG. 2A is a schematic view of an augmented reality device in the form of smart glasses, in accordance with some embodiments discussed herein;

FIG. 2B is a schematic view of an augmented reality device in the form of a cell phone, in accordance with some embodiments discussed herein;

FIG. 2C is a schematic view illustrating an example display of a cell phone where a sonar image and portions of the surrounding environment are both visible in the display, in accordance with some embodiments discussed herein;

FIG. 3A illustrates an example sonar image, in accordance with some embodiments discussed herein;

FIG. 3B is a schematic view illustrating an example display of an augmented reality device where the sonar image of FIG. 3A and portions of the surrounding environment are both visible in the display, in accordance with some embodiments discussed herein;

FIG. 4A is a schematic view illustrating an example display of an augmented reality device where a moving target is represented on the display and where a vector and text are both provided to indicate the velocity of the moving target, in accordance with some embodiments discussed herein;

FIG. 4B is a schematic view illustrating an example display of an augmented reality device where a moving target is represented on the display with a vector presented to indicate the movement direction of the moving target and with text provided to indicate other information such as the speed of the moving target, in accordance with some embodiments discussed herein;

FIGS. 5A-5B are schematic views illustrating an example display of an augmented reality device where the sonar image of FIG. 3A and portions of the surrounding environment are both visible in the display, with the sonar image being locked in position relative to the surrounding environment as the augmented reality device is pointed in different directions, in accordance with some embodiments discussed herein;

FIG. 5C is a schematic view illustrating an example display of an augmented reality device where the sonar image of FIG. 3A and portions of the surrounding environment are both visible in the display and where distance information is represented on the display, in accordance with some embodiments discussed herein;

FIG. 6A-6B are schematic views illustrating an example display of an augmented reality device where a sonar image and portions of the surrounding environment are both visible in the display and where a representation of a moving target is included in the display that remains highlighted on the moving target as the moving target moves through the surrounding environment, in accordance with some embodiments discussed herein;

FIG. 7A is a schematic view illustrating an example display of an augmented reality device similar to the one illustrated in FIG. 3A where a representation of an object is highlighted in the display, where a location is emphasized by a representation in the display, and where a path is represented to show a course to the location in the display, in accordance with some embodiments discussed herein;

FIG. 7B is a schematic view illustrating an example display of an augmented reality device similar to the one illustrated in FIG. 3A, where various contour lines are represented in the display, in accordance with some embodiments discussed herein;

FIG. 8A illustrates an example side scan sonar image, in accordance with some embodiments discussed herein;

FIG. 8B is a schematic view illustrating an example display of an augmented reality device similar to the one illustrated in FIG. 3A where the side scan sonar image of FIG. 8A is also presented in a pop up window, in accordance with some embodiments discussed herein;

FIG. 9A is a schematic view illustrating an example display of an augmented reality device that is similar to the one illustrated in FIG. 3A, with a live, forward scan sonar image also being presented in a pop up window, in accordance with some embodiments discussed herein;

FIG. 9B is a schematic view illustrating an example display of an augmented reality device that is similar to the one illustrated in FIG. 3A, with another live, forward scan sonar image being presented in a pop up window, in accordance with some embodiments discussed herein;

FIG. 10 illustrates a perspective view of an example sonar transducer assembly that includes three arrays, in accordance with some embodiments discussed herein;

FIG. 11 is a block diagram illustrating an example system with various electronic devices, marine devices, and secondary devices shown, in accordance with some embodiments discussed herein; and

FIG. 12 is a flow chart illustrating an example method for using an augmented reality device, in accordance with some embodiments discussed herein.

### DETAILED DESCRIPTION

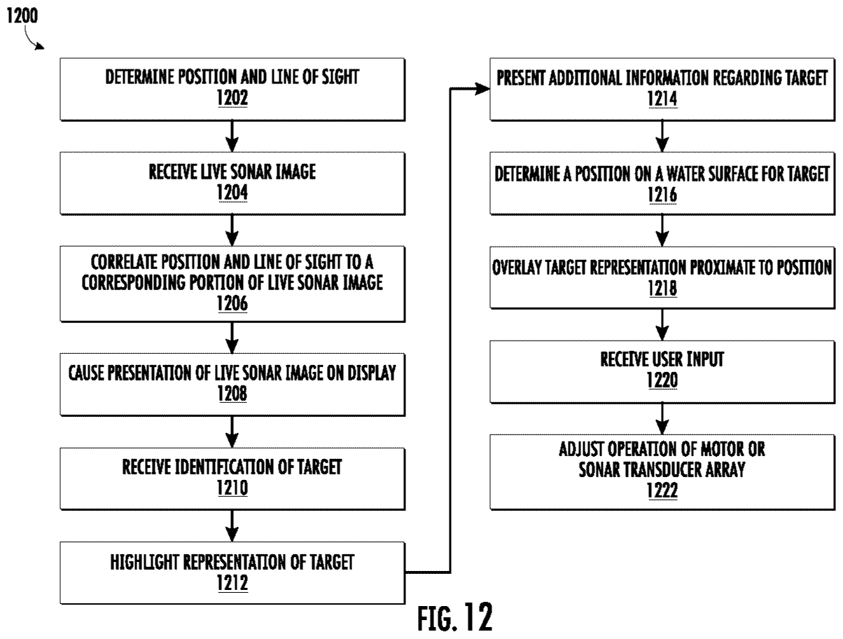

Example embodiments of the present invention now will be described more fully hereinafter with reference to the accompanying drawings, in which some, but not all embodiments of the invention are shown. Indeed, the invention may be embodied in many different forms and should not be construed as limited to the example embodiments set forth herein; rather, these embodiments are provided so that this disclosure will satisfy applicable legal requirements. Other than in the flow chart of FIG. 12, like reference numerals generally refer to like elements throughout. For example, reference numbers 326, 426A, 426B, 526A, 526B refer to displays.

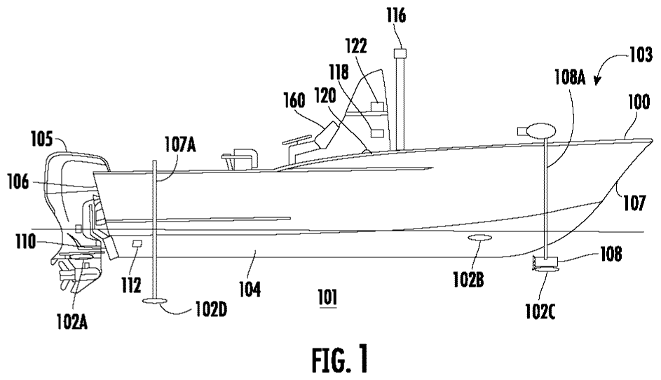

FIG. 1 illustrates an example watercraft 100 including various marine devices, in accordance with some embodiments discussed herein. As depicted in FIG. 1, the watercraft 100 (e.g., a vessel) is configured to traverse a marine environment, e.g. body of water 101, and may use one or more sonar transducer assemblies 102A, 102B, 102C, 102D disposed on and/or proximate to the watercraft. Notably, example watercraft contemplated herein may be surface watercraft, submersible watercraft, or any other implementation known to those skilled in the art. The sonar transducer assemblies 102A-102D may each include one or more sonar transducer elements (such as in the form of the example assemblies described herein) configured to transmit sound waves into a body of water, receive sonar returns from the body of water, and convert the sonar returns into sonar return data. Various types of sonar transducers may be provided—for example, a linear downscan sonar transducer, a conical downscan sonar transducer, a sonar transducer array, or a sidescan sonar transducer may be used. Each of the sonar transducer assemblies 102A-102D are configured to provide sonar data that may be stored and that may undergo further processing to form sonar images. The sonar data may include information representative of an underwater environment around a watercraft.

Depending on the configuration, the watercraft 100 may include a primary motor 105, which may be a main propulsion motor such as an outboard or inboard motor. Additionally, the watercraft 100 may include a trolling motor 108 configured to propel the watercraft 100 or maintain a position. The trolling motor 108 may comprise a shaft 108A, which may be rotatable and/or moved up and down in some embodiments. The one or more sonar transducer assemblies (e.g., 102A-102D) may be mounted in various positions and to various portions of the watercraft 100 and/or equipment associated with the watercraft 100. For example, the sonar transducer assembly may be mounted proximate to the transom 106 of the watercraft 100, such as depicted by sonar transducer assembly 102A. The sonar transducer assembly may be mounted to the bottom or side of the hull 104 of the watercraft 100, such as depicted by sonar transducer assembly 102B. The sonar transducer assembly may also be mounted to the trolling motor 108, such as depicted by sonar transducer assembly 102C. The sonar transducer assembly may also be mounted on its own shaft 107A, such as depicted by sonar transducer assembly 102D. Shaft 107A may be rotatable and/or moved up and down in some embodiments.

The watercraft 100 may also include one or more marine electronic devices 160, such as may be utilized by a user to interact with, view, or otherwise control various aspects of the various sonar systems described herein. In the illustrated embodiment, the marine electronic device 160 is positioned proximate the helm (e.g., steering wheel) of the watercraft 100—although other locations on the watercraft 100 are contemplated. Likewise, additionally or alternatively, a remote device (such as a user's mobile device) may include functionality of a marine electronic device.

The watercraft 100 may also comprise other components within the one or more marine electronic devices 160 or at the helm. In FIG. 1, the watercraft 100 comprises a radar 116, which is mounted at an elevated position (although other positions relative to the watercraft are also contemplated). The watercraft 100 also comprises an AIS transceiver 118, a direction sensor 120, and a camera 122, and these components are each positioned at or near the helm (although other positions relative to the watercraft 100 are also contemplated). Additionally, the watercraft 100 comprises a rudder 110 at the stern of the watercraft 100, and the rudder 110 may be positioned on the watercraft 100 so that the rudder 110 rests in the body of water 101. In other embodiments, these components may be integrated into the one or more electronic devices 160 or other devices. Another example device on the watercraft 100 includes a temperature sensor 112 that may be positioned so that it rests within or outside of the body of water 101. Other example devices include a wind sensor, one or more speakers, and various vessel devices/features (e.g., doors, bilge pump, fuel tank, etc.), among other things. Additionally, one or more sensors may be associated with marine devices. For example, a sensor may be provided to detect the position of the primary motor 105, the trolling motor 108, or the rudder 110. The watercraft 100 includes a bow 103 at the front end of the watercraft 100, and the watercraft 100 includes a keel 107, which may extend along a centerline of the watercraft 100 and generally along the forward direction of the watercraft 100.

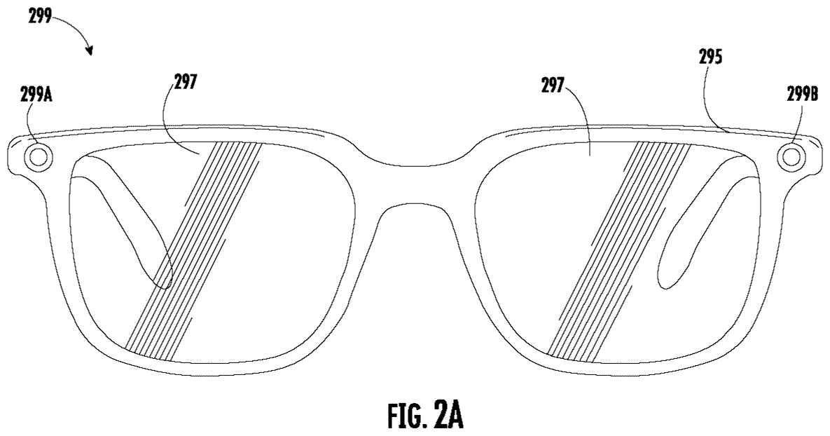

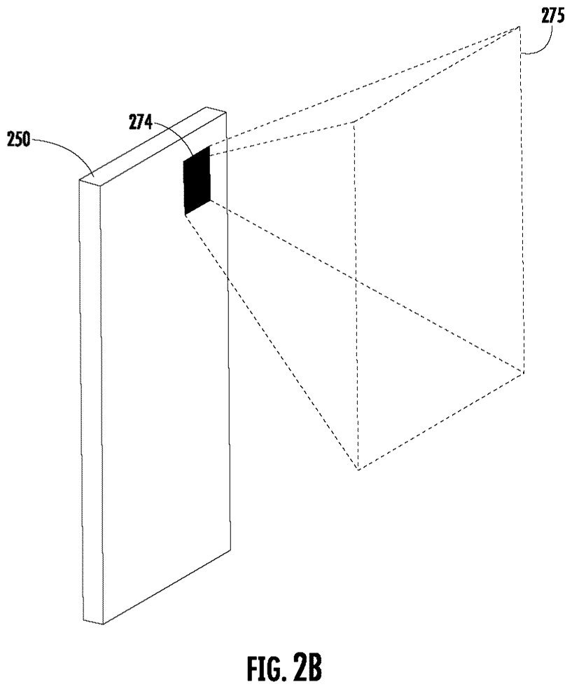

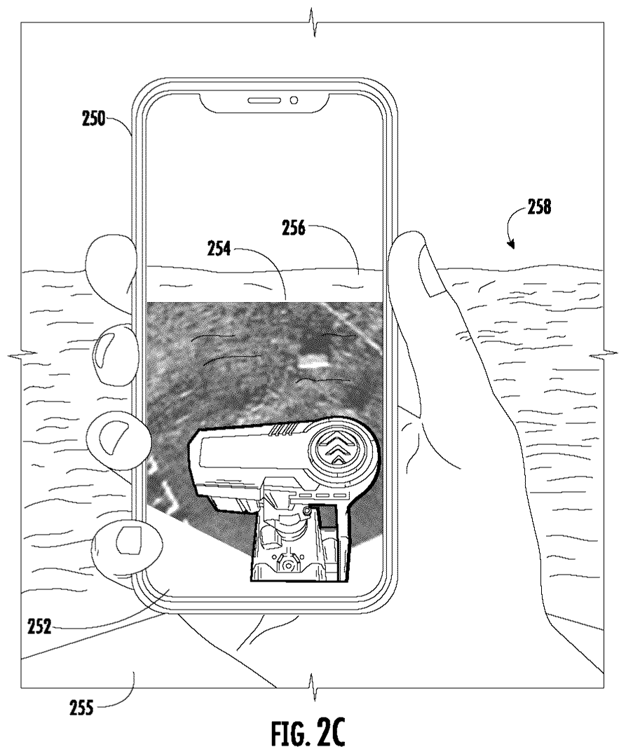

Various types of augmented reality devices may be used, and the smart glasses 299 illustrated in FIG. 2A provide one example augmented reality device. The smart glasses 299 include a first camera 299A on one side of the smart glasses 299 and a second camera 299B on the second side of the smart glasses 299. However, only one camera may be provided in other embodiments, or three or more cameras may be utilized. Camera(s) may also be positioned in other locations. The cameras 299A, 299B are configured to generate images of the environment, and these images may be utilized to form an augmented reality image that is presented on the lenses 297 of the smart glasses 299. Cameras 299A, 299B may be configured to generate one or more images of a surrounding environment. The smart glasses 299 also include a wearable frame 295 configured to be worn by a user.

The augmented reality images presented on the smart glasses 299 may be similar to the other augmented reality images that are presented on the cell phone and the displays illustrated in the figures and described herein. The lenses 297 of the smart glasses 299 may serve as the display in the smart glasses 299. While the augmented reality device is provided in the form of smart glasses 299 in FIG. 2A, the augmented reality device may be provided in other forms such as a phone (e.g., a cell phone such as a smart phone), a tablet, a computer, a headset, or a marine electronic device.

A live sonar image may be presented on the lenses 297 of the smart glasses 299 so that the live sonar image is shown in lenses 297 in a partially transparent manner, with both the portion of the surrounding environment and a corresponding portion of the live sonar image being visible. The portion of the surrounding environment corresponds to a current viewpoint of the wearable frame 295 of the smart glasses 299 such that the user would otherwise see that portion of the surrounding environment if the smart glasses 299 were not present. Where smart glasses 299 are used, the user may simply view the surrounding environment through the lenses 297, and live sonar images may be shown in the lenses in a partially transparent manner so that both the surrounding environment and the live sonar images are visible. However, in some embodiments, images of the surrounding environment may be captured via a camera, and both the live sonar images and the images of the surrounding environment may be shown on the lenses 297.

In some embodiments, the smart glasses 299 or some other augmented reality device may be configured to record a live video feed and send the live video feed to the marine electronic device 160 (see FIG. 1), to the one or more memory devices, to an application on a phone or another device, or to another location. The smart glasses 299 and other augmented reality devices described herein may therefore be used to record and stream their activity. Wireless streaming may occur with limited or minimal lag time. This may be beneficial for television coverage of fishing tournaments or other water sports, for personal use, etc. Where smart glasses 299 are used, the live video feed may be provided from the point of view of the person wearing the smart glasses 299.

In some embodiments, the smart glasses 299, another augmented reality device, or some other device may receive a user input from a user. This user input may be provided in the form of a particular hand gesture, a voice command, an eye movement, a head movement or some other body movement, or in some other manner. Based on the user input that is received, operation of a watercraft may be adjusted. For example, the operation of a motor or a sonar transducer array may be adjusted based on the user input. Operation of the motor may be adjusted by turning the motor on or off, by changing an orientation of the motor (e.g., by rotating the shaft 108A of the trolling motor 108), by changing a motor speed, etc. Operation of the sonar transducer array may be adjusted by turning the sonar transducer array on or off, by changing an orientation of the sonar transducer array (e.g., by rotating the shaft 107A associated with sonar transducer array 102D), etc. Rotation of shafts 107A, 108A may be accomplished using a motor or another actuator associated with the shafts 107A, 108A to generate rotation of the shafts 107A, 108A.

The camera on a cell phone or another electronic device may be configured to generate images for a specific field of view, and a location of interest or a representation for the location of interest that is within the field of view may be identified. As illustrated in FIG. 2B, schematic views are provided illustrating the field of view 275 of a camera 274 on an augmented reality device 250 in the form of a cell phone. The field of view 275 is illustrated in the shape of a rectangular pyramid, but the field of view 275 may be provided in other shapes. The shape of the field of view 275 may be dependent upon the shape of the camera 274 and/or the shape of the display on the camera 274. In some embodiments, the field of view 275 may be increased or decreased in size. For example, where the user enters a command to zoom in at the augmented reality device 250, the field of view 275 may decrease in size, and where the user enters a command to zoom out on the augmented reality device 250, the field of view 275 may increase in size. Camera 274 may be configured to generate one or more images of a surrounding environment.

FIG. 2C is a schematic view illustrating an example display 252 of an augmented reality device 250 in the form of a cell phone where a live sonar image 254 and portions of the surrounding environment 256 are both visible in the display 252. In FIG. 2C, the watercraft 255 is visible at the bottom of the display 252. Additionally, the user may point a camera of the augmented reality device 250 towards the surrounding environment 258, and portions of the surrounding environment 256 may be presented on the display.

The portions of the surrounding environment 256 presented on the display 252 may be one or more images or videos of the surrounding environment that are captured using a camera. Any videos captured may include a plurality of still images. The display 252 may be a screen of the augmented reality device 250. The image(s) or video of the surrounding environment 256 may be presented on the display 252 alongside the live sonar image 254 so that both the image(s) of the surrounding environment 256 and the corresponding portion of the live sonar image 254 are visible on the display 252.

While the augmented reality device 250 is provided in the form of a cell phone in FIG. 2C, the augmented reality device may be provided in other forms such as a tablet, a computer, a headset, or a marine electronic device.

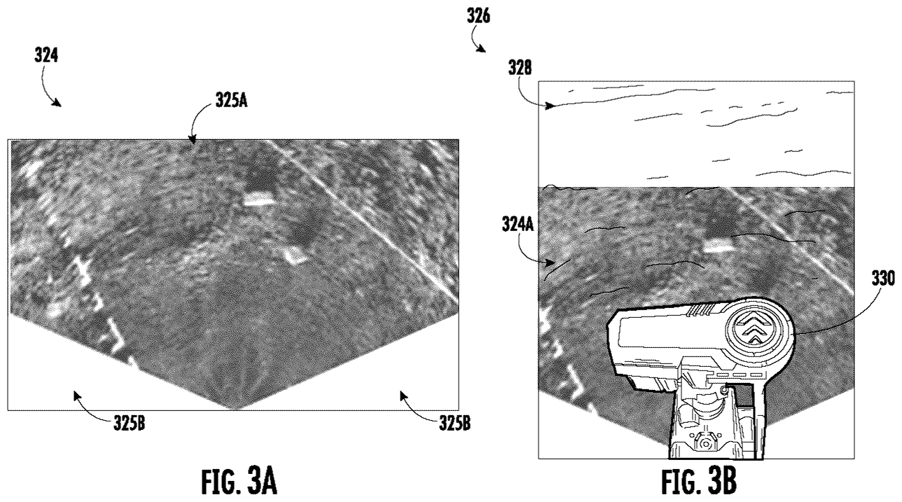

FIG. 3A illustrates an example live sonar image 324. As used here, a “live” sonar image may be a sonar image that is updated at regular intervals (e.g., multiple times a second, every second, every 6 seconds, every 15 seconds, every 30 seconds, every minute, etc.). The live sonar image 324 is a forward live sonar image, but other types of sonar images may be used. The live sonar image 324 includes detail on the underwater environment in a first area 325A, but the live sonar image 324 does not include detail on the underwater environment in areas 325B as these areas represent locations falling outside of the range of the sonar transducer assemblies used to form the live sonar image 324. Additional detail regarding example formation and presentation of some example “live” sonar images can be found in U.S. Publication No. 2022/0035026, entitled “Beamforming Sonar System with Improved Sonar Image Functionality, and Associated Methods”, filed Jul. 31, 2020, which is incorporated by reference herein.

FIG. 3B is a schematic view illustrating an example display 326 of an augmented reality device where the sonar image of FIG. 3A and portions of the surrounding environment are both visible in the display 326. The positioning of the live sonar image 324A may be correlated to corresponding positions in the surrounding environment 328. Thus, as the user looks in the environment, the live sonar image 324A may appear locked in place relative to the environment from the perspective of the user. A motor 330 is visible as the user is looking off of the front of the watercraft in FIG. 3B. However, the user may look off of the watercraft in other directions in other embodiments. From the viewpoint of the user, the live sonar image 324A may overlayed or superimposed on the surrounding environment so that both the live sonar image 324A and the surrounding environment are visible, and the live sonar image 324A may be shown on the display in a partially transparent manner so that the live sonar image 324A does not entirely obscure the visibility of the surrounding environment.

Smart glasses or a headset may serve as an augmented reality device in some embodiments. Where this is the case, the display of the augmented reality device may be provided in the form of lenses in the smart glasses or the headset. The live sonar image may be presented on at least one portion of the lenses in a partially transparent manner so that both the portion of the surrounding environment and the corresponding portion of the live sonar image are visible.

A phone, a tablet, a computer, a headset, or a marine electronic device may serve as an augmented reality device in some embodiments. Where this is the case, the augmented reality device may include a screen that serves as the display, and the augmented reality device may also include a camera configured to generate one or more images of the surrounding environment. The image(s) of the surrounding environment may be presented on the screen alongside the live sonar image so that both the one or more images of the surrounding environment and the corresponding portion of the live sonar image are visible on the screen.

While only one sonar image is illustrated in FIG. 3B, multiple sonar images may be presented on the display in other embodiments, with the sonar images each superimposed on the surrounding environment or images thereof in the appropriate positions. For example, portions of a forward scan sonar image may be presented on a display at areas in front of a watercraft representation, portions of a side scan sonar image may be presented on a display at areas to the sides of the watercraft representation, and portions of other sonar images may be presented on the display at appropriate positions as well.

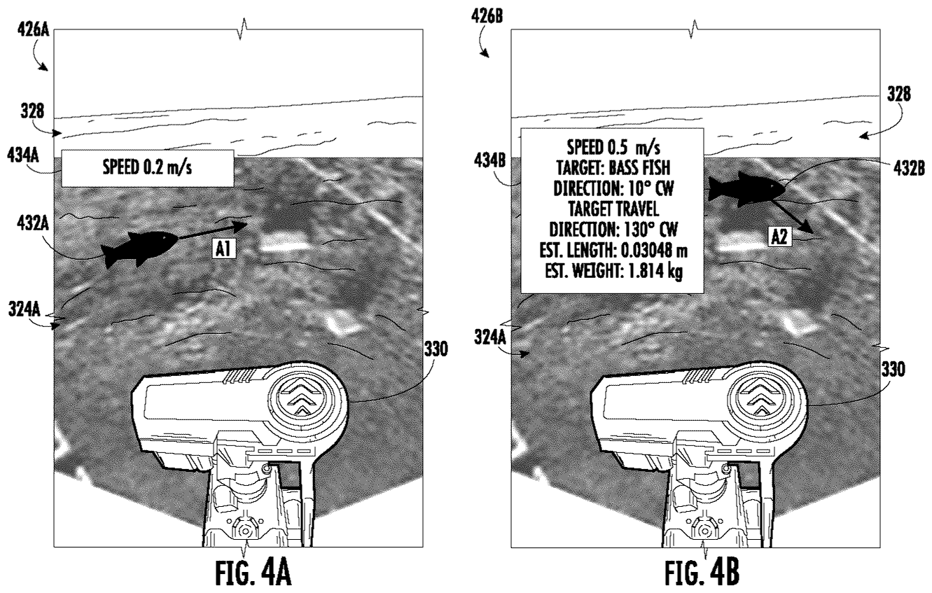

In FIGS. 4A-4B, a moving target is represented in the display. This moving target may be a fish or another underwater animal, but moving targets may be debris or floating objects in other embodiments. As the moving target moves through the environment, a movement speed or a direction vector for the moving target may be overlayed on the display of the augmented reality device.

In FIG. 4A, an example display 426A of an augmented reality device is illustrated where a moving target representation 432A is illustrated on the display. The moving target represented by the moving target representation 432A is a fish, but the moving target may be another underwater animal or another moving target. Furthermore, an arrow A1 and a window 434A with text are both provided to indicate the direction and speed of the moving target.

In FIG. 4B, an example display 426B of an augmented reality device is illustrated where a moving target representation 432B is illustrated on the display. Furthermore, an arrow A2 and a window 434B with text are both provided to indicate the direction and speed of the moving target. In FIG. 4B, the information provided in the window 434B is more detailed than the information provided in the window 434A. While the window 434A indicates that the velocity is 0.2 meters per second, the window 434B indicates the velocity (0.5 meters per second at a later time), an identification of the target as a bass fish, a direction of the moving target representation 432B relative to the watercraft (10 degrees clockwise from the perspective illustrated in FIG. 4B), a travel direction for the moving target representation 432B (130 degrees clockwise from the forward direction from the perspective illustrated in FIG. 4B), an estimated length of 0.03048 meters, and an estimated weight of about 1.1814 kilograms.

The ability to identify a particular type of fish may be incorporated if a particular species can be identified based on size, GPS location, movement speed, etc. The target may be detected by the user and then selected in some embodiments so that the target may continue to be tracked. However, the target may be detected in other ways, such as through the use of machine learning, artificial intelligence, and/or algorithm based approaches for automatic identification of objects.

In some embodiments, the user may optionally select to hide the windows 434A, 434B, to show window 434A for more limited information, or to show window 434B for more detailed information. This selection may be made by using a particular hand gesture (e.g., pointing) in a particular direction, a voice command, a particular eye movement, or another head or body movement. In some cases, the selection may be made by touching the display in a particular location or in a particular manner (e.g., by pressing or swiping on the window 434A). Additionally or alternatively, the selection may be made on a separate computer, computer application, etc., and the setting may be updated on the augmented reality device based on the preferences of the user.

The arrows A1, A2 may be provided in the form of a vector in some embodiments, with the distance or size of the arrows A1, A2 being representative of the speed and with the direction of the arrows A1, A2 being representative of the travelling direction and/or the attitude direction of the target. Where the attitude direction of the target and the travelling direction of the target are different (e.g., due to current drift), the attitude direction of the moving target representations 432A, 432B may be indicated by the posture of the moving target representations 432A, 432B and the travelling direction of the target may be represented by the arrow A1, A2. The fish movement speed and direction vectors (e.g., arrows A1, A2) may be displayed and constantly updated for a specific selected target.

In various embodiments, an augmented reality device may be configured to determine a position and a line of sight for the augmented reality device or a wearable frame thereof, and the augmented reality device may be configured to receive a live sonar image. The augmented reality device may be configured to correlate the position and the line of sight of the augmented reality device to a corresponding portion of the live sonar image. The augmented reality device may also be configured to cause presentation of the live sonar image on the display so that the portion of the surrounding environment and the corresponding portion of the live sonar image are both visible in the display from the perspective of a user.

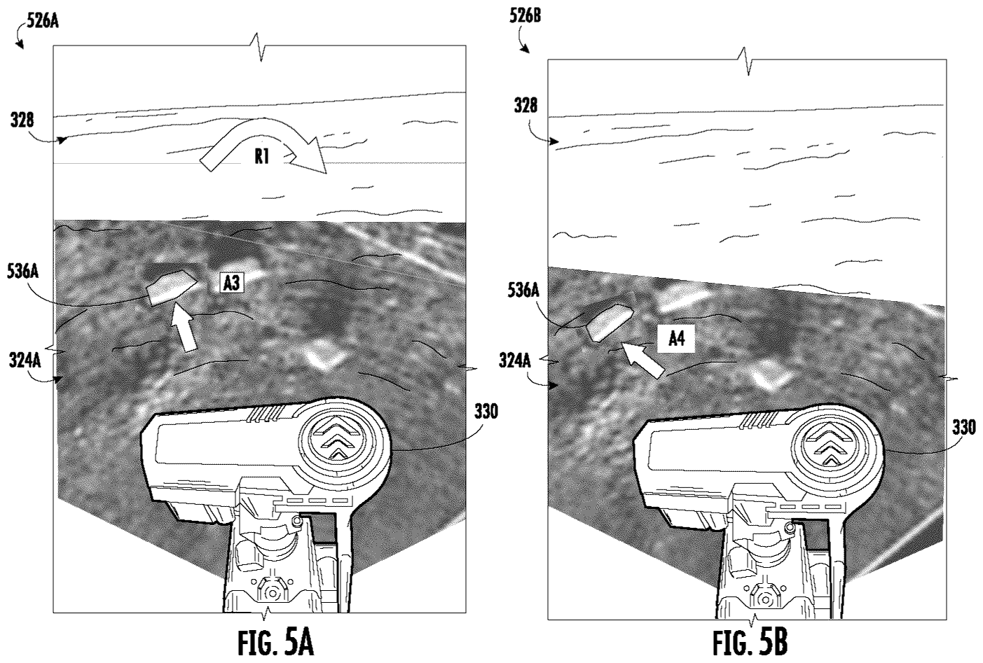

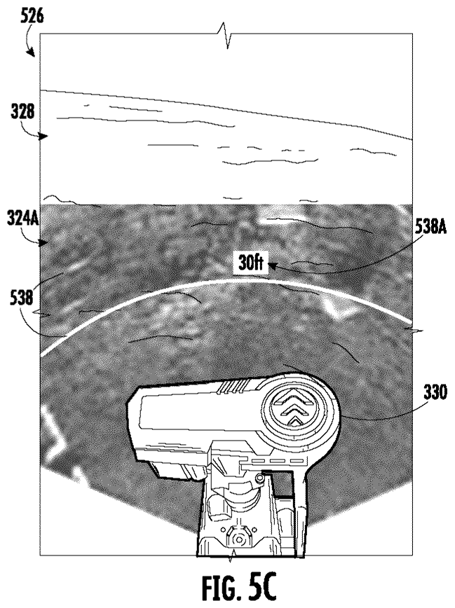

An example of this is demonstrated in FIGS. 5A and 5B. FIGS. 5A-5B are schematic views illustrating example displays 526A, 526B of an augmented reality device where the live sonar image 324A of FIG. 3A and portions of the surrounding environment 328 are both visible in the displays 526A, 526B. The live sonar image 324A is locked in position relative to the surrounding environment as the augmented reality device is directed in different directions. For example, a location 536A is positioned at a first position on the first display 526A. Once the user turns the augmented reality device towards the right as indicated by the arrow R1, the augmented reality device may be directed at least partially towards a new portion of the surrounding environment. As the augmented reality device is rotated towards the right, the live sonar image 324A may remain fixed relative to corresponding portions of the surrounding environment. For example, in the second display 526B, the location 536A is positioned at a new position relative to its position in the first display 526A.

The location 536A may be a target or a location of interest that the user wishes to keep track of. The location 536A is an underwater, stationary object (e.g., an elevation in the floor of the body of water), but other objects may be tracked. The location 536A may be emphasized by providing an outline around the location 536A, by using arrows (e.g., arrows A3, A4).

The augmented reality device may be configured to enable a selection or deselection of the location 536A by a user by detecting a particular hand gesture in a particular direction, a voice command, a particular eye movement, or another head or body movement. Additionally or alternatively, the location 536A may be selected or deselected by a user touching the display or the location 536A may be selected on a separate computer, computer application, etc.

In FIG. 5C, an example display 526 of an augmented reality device is illustrated where the sonar image of FIG. 3A and portions of the surrounding environment are both visible in the display and where distance information is represented on the display 526. The display 526 is similar to other displays described herein, except a representation 538A is provided to indicate a distance (e.g., 30 feet) from the user and representation 538 is provided in the form of a line to indicate locations that are positioned at that distance (e.g., 30 feet) away from the augmented reality device. The representations 538, 538A may be beneficial to provide the user with an indication of a distance that the user must cast his or her bait to reach an intended casting target.

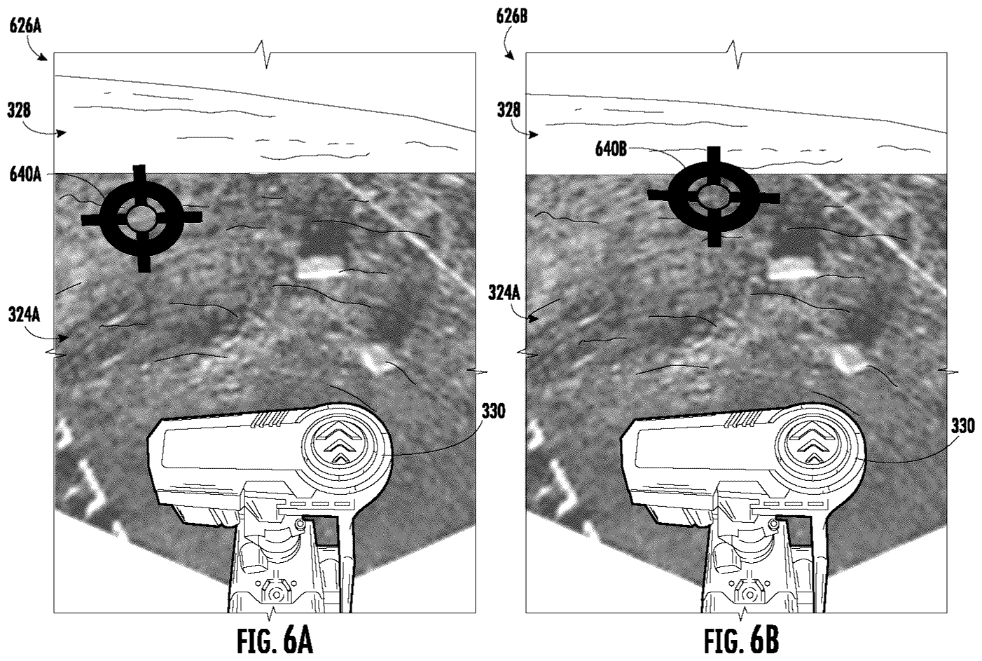

FIG. 6A-6B are schematic views illustrating example displays 626A, 626B of an augmented reality device where a sonar image and portions of the surrounding environment are both visible in the display, with target representations 640A, 640B of the moving target in the displays 626A, 626B remaining highlighted on the moving target as the moving target moves through the surrounding environment.

The augmented reality device may be configured to enable a selection or deselection of the target by a user by detecting a particular hand gesture in a particular direction, a voice command, a particular eye movement, or another head or body movement. Additionally or alternatively, the target may be selected or deselected by a user touching the display or the location may be selected on a separate computer, computer application, etc.

Augmented reality devices may be configured to determine a position on a water surface corresponding to a location for the moving target, and the augmented reality devices may also be configured to overlay a target representation 640A, 640B proximate to this position on the display of the augmented reality devices. The location may be a current location of the moving target, but the location may also be an anticipated location of the moving target. Where an anticipated location is used, the anticipated location may be the location where the moving target will likely be located in 1 second, 2 seconds, 3 seconds, etc. if the moving target continues to travel at the same velocity. Alternatively, the anticipated location may be the location where the moving target will likely be located after a certain time period, with the time period being variable based on the casting distance. This may be beneficial as the time to cast 5 feet from the boat may be different from the time to cast 40 feet from the boat. Using an anticipated location may be beneficial for fishermen who are looking for the appropriate place to cast their bait.

In some embodiments, one or more representations may be presented on the display to provide the user helpful information during navigation of the watercraft, while fishing, etc. For example, the augmented reality device may be configured to receive an identification of a target and to cause a representation of the target to be highlighted. The identification of the target may be obtained from a user using the approaches for user input described herein, or the target identification may be received through the use of machine learning, artificial intelligence, algorithms, etc. to automatically identify targets.

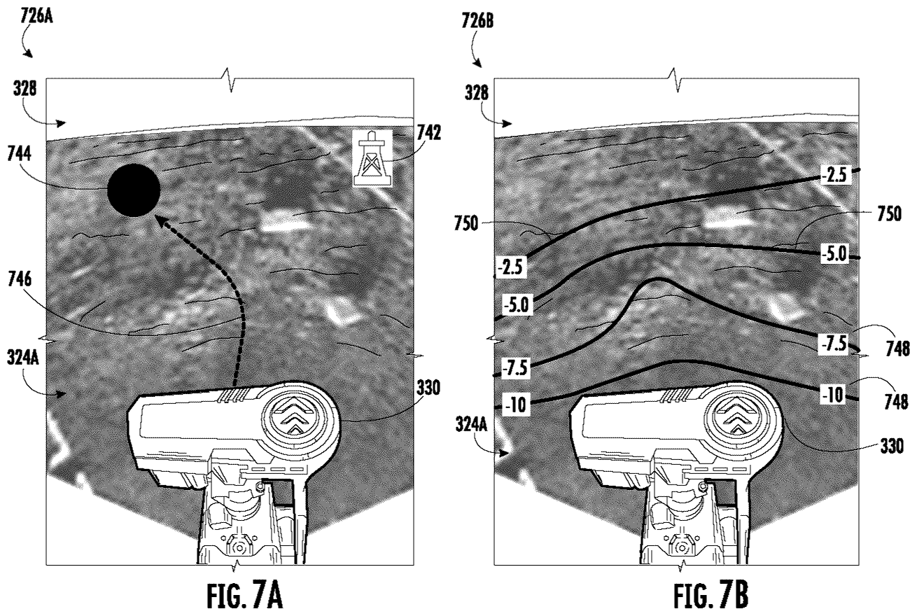

In the display 726A of FIG. 7A, a target location representation 744 is illustrated to indicate a target location that the user wishes to travel to. The target location may be a saved location where fish are frequently located, but the target location may be some other location (e.g., a docking location). A travel path representation 746 may be illustrated to indicate an ideal travel path for the watercraft to a target location. The travel path representation 746 is curved, but the travel path representation 746 may be provided in a straight line or in another shape in other embodiments. A hazard representation 742 is also illustrated in FIG. 7A, with the hazard being a buoy floating on the surface of the water. Hazard representations may be used to indicate the presence of other hazards such as sandbars, underwater animals or objects positioned under the water, etc.

In the display 726B of FIG. 7B, topographical representations are provided to indicate depth information in the surrounding environment. For example, depth values 748 are presented alongside corresponding contour lines 750. Depth values 748 are presented in meters, but other units may be used.

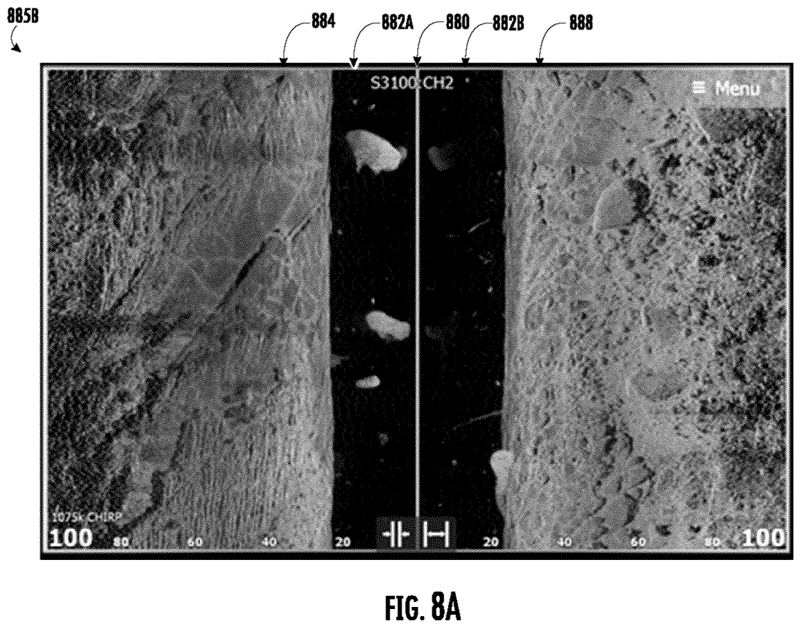

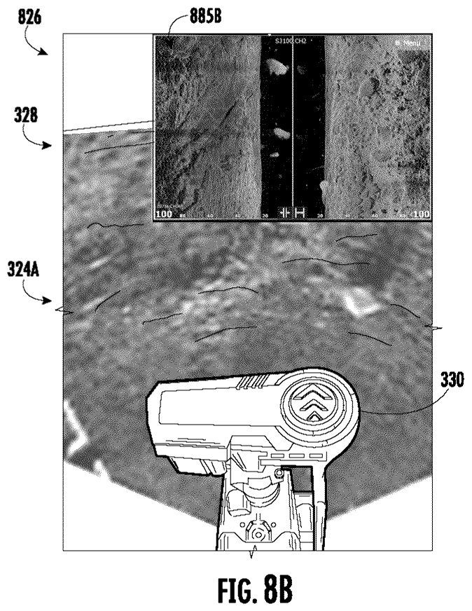

FIG. 8A is an example sidescan sonar image 885B, which may be a live sonar image and a structure scan image. In the sidescan sonar image 885B, a centerline 880 is illustrated, and one or more sonar transducer assemblies used to generate the sonar data of the sidescan sonar image 885B may be positioned and aimed relative to the centerline 880. Given that the sidescan sonar image 885B is a sidescan sonar image, the sonar transducer assemblies are sidescan sonar transducers and surface-based sonar return signals are generally not received in the zones 882A, 882B. These zones 882A, 882B correspond to locations within the water column underneath the watercraft, where typical sonar returns correspond to fish, tree branches, or other objects floating in the water column. The zones 884 and 888 illustrate portions of the underwater environment on each side of the watercraft.

FIG. 8B is a schematic view illustrating an example display of an augmented reality device that is similar to the one illustrated in FIG. 3A. However, in FIG. 8B, a second image is presented on the display 826 in a pop up window. The second image is a sidescan sonar image 885B that is a live sonar image, but the second image may be provided in the form of another type of sonar image, a radar image, an underwater image, a video, an image, etc.

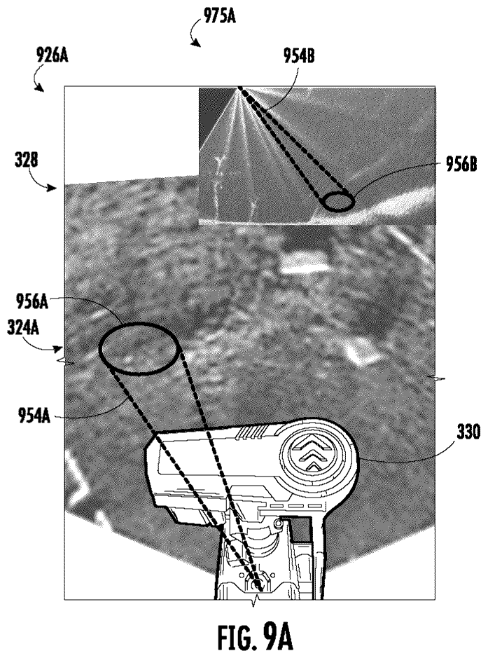

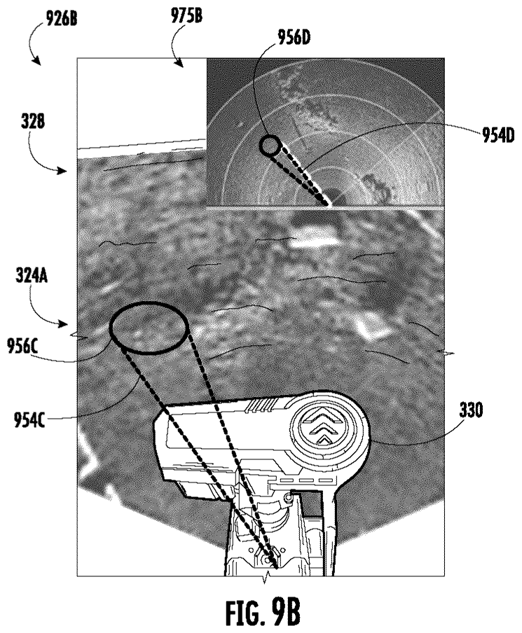

FIG. 9A is a schematic view illustrating an example display of an augmented reality device where a display 926A similar to the one illustrated in FIG. 3A is presented. However, in the display 926A of FIG. 9A, a second image 975A is presented on the display 926A in a pop up window. The second image 975A is a live, forward scan sonar image, but the second image 975A may be provided in the form of another type of sonar image, a radar image, an underwater image, a video, etc.

A particular location may be emphasized in both the second image 975A and in the live sonar image 324A, allowing the user to quickly identify where that location is positioned in both of the images and allowing the user to better understand the views shown in the images. The location may be a target location or some other location of interest. For example, a target area 956A is presented in the live sonar image 324A and target area 956B is presented in the second image 975A, with these two target areas 956A, 956B representing the same physical location. Additionally or alternatively, lines 954A, 954B may be presented in the sonar images 324A, 975A to represent the sonar viewing angles used to obtain sonar data at the target areas 956A, 956B.

FIG. 9B is a schematic view illustrating an example display of an augmented reality device where a display 926B similar to the one illustrated in FIG. 3A is presented. However, in the display 926B of FIG. 9B, a second image 975B is presented on the display 926B in a pop up window. The second image 975B is another live, forward scan sonar image, but the second image 975B may be provided in the form of another type of sonar image, a radar image, an underwater image, a video, an image, etc. For example, a rear view video or images may show views opposite the current viewing angle of the augmented reality device.

Similar to the display 926A of FIG. 9A, the display 926B of FIG. 9B may have a particular location emphasized in both the second image 975B and in the live sonar image 324A, allowing the user to quickly identify where that location is positioned in both of the images. This location may be a target location or some other location of interest. For example, a target area 956C is presented in the live sonar image 324A and target area 956D is presented in the second image 975B, with these two target areas 956C, 956D representing the same physical location. Additionally or alternatively, lines 954C, 954D may be presented in the sonar images 324A, 975B to represent the sonar viewing angles used to obtain data at the target areas 956C, 956D.

While two sonar images are presented on the display in FIGS. 8B, 9A, and 9B, three or more sonar images may be presented on a display in other embodiments. In some embodiments, a user may provide input to change the sonar image or other images that are presented on the display. For example, the user input may be provided in the form of a particular hand gesture, a voice command, an eye movement, a head movement or some other body movement, or in some other manner.

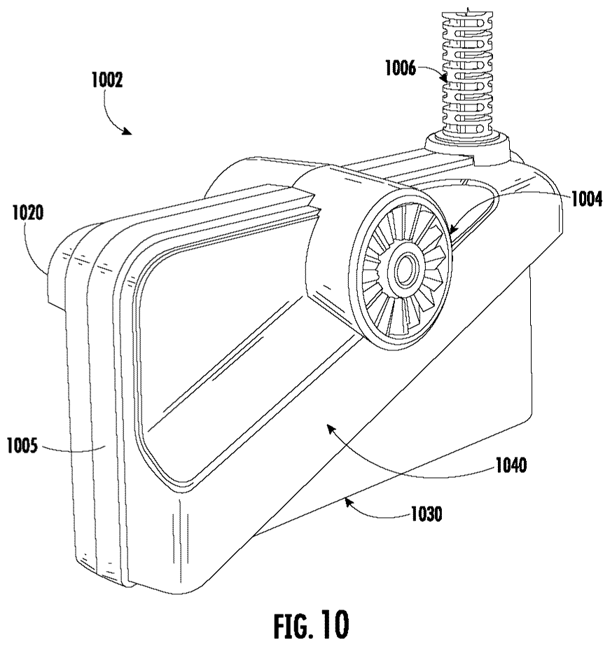

FIG. 10 illustrates an example sonar transducer assembly 1002 that may be used to obtain sonar data. The sonar transducer assembly 1002 includes a housing 1005 that houses the three arrays 1020, 1030, 1040. Notably, the housing 1005 includes one or more mounting features (e.g., a ratchet-type mounting feature 1004 for enabling secured attachment in different orientations). The cable 1006 provides a safe channel for running various wires used in conjunction with the arrays. Notably, the X-plus-line configuration of the arrays enables some benefits for the sonar transducer assembly 1002. For example, the housing 1005 of the sonar transducer assembly 1002 may maintain a small footprint and still provide a straight bottom that enables a user to more easily comprehend the position of the center array (and, thus, determine and orient the sonar transducer assembly 1002 properly with respect to the watercraft for the desired coverage). Further details regarding the sonar transducer assembly 1002 and other sonar transducer assemblies may be found in U.S. Pat. No. 11,921,200, entitled “Live Down Sonar View”, which is incorporated by reference herein in its entirety.

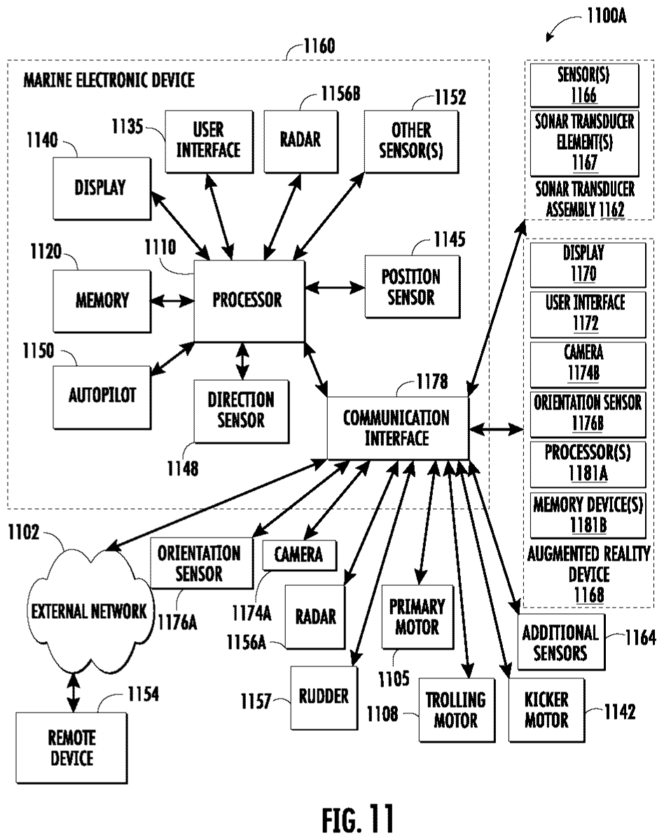

The watercraft and other systems described herein may comprise various electrical components, and FIG. 11 is a block diagram illustrating electrical components that may be provided on in one example system.

An augmented reality device 1168 is also included. The augmented reality device 1168 may be a phone such as a cell phone, smart glasses, a display, a tablet, a computer, a headset, or another electronic device. The augmented reality device 1168 comprises a display 1170, with the display 1170 having a screen. In some embodiments, the display 1170 may be a touch display that is configured to receive input from a user by detecting the user touching the display 1170 with a finger. A user interface 1172 is also provided in the augmented reality device 1168, and the user interface 1172 may include one or more input buttons, a speaker, a microphone, a keypad, and other mechanisms to enable the user to input commands. The augmented reality device 1168 may also comprise a camera 1174B to obtain one or more images, which may be live images. The augmented reality device 1168 may also comprise an orientation sensor 1176B. The orientation sensor 1176B may be configured to determine the orientation at the camera 1174B. Alternatively, a camera 1174A and an associated orientation sensor 1176A may be positioned at another location on the watercraft, with the orientation sensor 1176A being configured to determine the orientation at the camera 1174A. Cameras 1174A, 1174B may be video cameras in some embodiments. The augmented reality device 1168 may also include one or more processors 1181A and one or more memory devices 1181B.

The system 1100 may comprise numerous marine devices. As shown in FIG. 11, a sonar transducer assembly 1162, a radar 1156A, a rudder 1157, a primary motor 1105, a trolling motor 1108, and additional sensors/devices 1164 may be provided as marine devices, but other marine devices may also be provided. One or more marine devices may be implemented on the marine electronic device 1160 as well. For example, a position sensor 1145, a direction sensor 1148, an autopilot 1150, and other sensors/devices 1152 may be provided within the marine electronic device 1160. These marine devices can be integrated within the marine electronic device 1160, integrated on a watercraft at another location and connected to the marine electronic device 1160, and/or the marine devices may be implemented at a remote device 1154 in some embodiments. The system 1100 may include any number of different systems, modules, or components, each of which may comprise any device or means embodied in either hardware, software, or a combination of hardware and software configured to perform one or more corresponding functions described herein.

The marine electronic device 1160 may include at least one processor 1110, a memory 1120, a communications interface 1178, a user interface 1135, a display 1140, autopilot 1150, and one or more sensors (e.g. position sensor 1145, direction sensor 1148, other sensors/devices 1152). One or more of the components of the marine electronic device 1160 may be located within a housing or could be separated into multiple different housings (e.g., be remotely located).

The processor(s) 1110, 1181A may be any means configured to execute various programmed operations or instructions stored in a memory device (e.g., memory devices 1120, 1181B) such as a device or circuitry operating in accordance with software or otherwise embodied in hardware or a combination of hardware and software (e.g. a processor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions of the processor(s) 1110, 1181A as described herein.

In an example embodiment, the memory device(s) 1120, 1181B may include one or more non-transitory storage or memory devices such as, for example, volatile and/or non-volatile memory that may be either fixed or removable. The memory device(s) 1120, 1181B may be configured to store software instructions, computer program code, radar data, and additional data such as sonar data, chart data, location/position data in a non-transitory computer readable medium for use, such as by the processor(s) 1110, 1181A for enabling the marine electronic device 1160 to carry out various functions in accordance with example embodiments of the present invention. For example, the memory device(s) 1120, 1181B could be configured to buffer input data for processing by the processor(s) 1110, 1181A. Additionally or alternatively, the memory device(s) 1120, 1181B could be configured to store instructions for execution by the processor(s) 1110, 1181A. The memory device(s) 1120, 1181B may include computer program code that is configured to, when executed, cause the processor(s) 1110, 1181A to perform various methods described herein. The memory device(s) 1120, 1181B may serve as a non-transitory computer readable medium having stored thereon software instructions that, when executed by a processor, cause methods described herein to be performed.

The communications interface 1178 may be configured to enable communication to external systems (e.g. an external network 1102). In this manner, the marine electronic device 1160 may retrieve stored data from a remote device 1154 via the external network 1102 in addition to or as an alternative to the onboard memory 1120. Additionally or alternatively, the marine electronic device 1160 may transmit or receive data, such as radar signal data, radar return data, radar image data, path data or the like to or from a sonar transducer assembly 1162. In some embodiments, the marine electronic device 1160 may also be configured to communicate with other devices or systems (such as through the external network 1102 or through other communication networks, such as described herein). For example, the marine electronic device 1160 may communicate with a propulsion system of the watercraft 100 (e.g., for autopilot control), a remote device (e.g., a user's mobile device, a handheld remote, etc.), or another system.

The communications interface 1178 of the marine electronic device 1160 may also include one or more communications modules configured to communicate with one another in any of a number of different manners including, for example, via a network. In this regard, the communications interface 1178 may include any of a number of different communication backbones or frameworks including, for example, Ethernet, the NMEA 2000 framework, GPS, cellular, Wi-Fi, or other suitable networks. The network may also support other data sources, including GPS, autopilot, engine data, compass, radar, etc. In this regard, numerous other peripheral devices (including other marine electronic devices or transducer assemblies) may be included in the system 1100. In some embodiments, the augmented reality device 1168 may include a communications interface similar to communications interface 1178.

The position sensor 1145 may be configured to determine the current position and/or location of the marine electronic device 1160 (and/or the watercraft 100). For example, the position sensor 1145 may comprise a GPS, bottom contour, inertial navigation system, such as machined electromagnetic sensor (MEMS), a ring laser gyroscope, or other location detection system. Alternatively or in addition to determining the location of the marine electronic device 1160 or the watercraft 100, the position sensor 1145 may also be configured to determine the position and/or orientation of an object outside of the watercraft 100. In some embodiments, the augmented reality device 1168 may include a position sensor similar to position sensor 1145.

The displays 1140, 1170 (e.g. one or more screens) may be configured to present images and may include or otherwise be in communication with user interfaces 1135, 1172 configured to receive input from a user. The display 1140, 1170 may be, for example, a conventional LCD (liquid crystal display), a touch screen display, mobile device, or any other suitable display known in the art upon which images may be displayed.

In some embodiments, the displays 1140, 1170 may present one or more sets of data (or images generated from the one or more sets of data). Such data includes chart data, radar data, sonar data, weather data, location data, position data, orientation data, sonar data, or any other type of information relevant to the watercraft. Radar data may be received from radar 1156A located outside of a marine electronic device 1160, radar 1156B located in a marine electronic device 1160, or from radar devices positioned at other locations, such as remote from the watercraft. Additional data may be received from marine devices such as a sonar transducer assembly 1162, a primary motor 1105 or an associated sensor, a trolling motor 1108 or an associated sensor, an autopilot 1150, a rudder 1157 or an associated sensor, a position sensor 1145, a direction sensor 1148, other sensors/devices 1152, a remote device 1154, onboard memory 1120 (e.g., stored chart data, historical data, etc.), or other devices.

The user interfaces 1135, 1172 may include, for example, a keyboard, keypad, function keys, buttons, a mouse, a scrolling device, input/output ports, a touch screen, or any other mechanism by which a user may interface with the system.

Although the display 1140 of FIG. 11 is shown as being directly connected to the processor(s) 1110 and within the marine electronic device 1160, the display 1140 could alternatively be remote from the processor(s) 1110 and/or marine electronic device 1160. Likewise, in some embodiments, the position sensor 1145 and/or user interface 1135 could be remote from the marine electronic device 1160.

The marine electronic device 1160 may include one or more other sensors/devices 1152, such as configured to measure or sense various other conditions. The other sensors/devices 1152 may include, for example, an air temperature sensor, a water temperature sensor, a current sensor, a light sensor, a wind sensor, a speed sensor, or the like.

A sonar transducer assembly 1162 is also provided in the system 1100. The sonar transducer assembly 1162 illustrated in FIG. 11 may include one or more sonar transducer elements 1167, such as may be arranged to operate alone or in one or more transducer arrays. In some embodiments, additional separate sonar transducer elements (arranged to operate alone, in an array, or otherwise) may be included. As indicated herein, the sonar transducer assembly 1162 may also include a sonar signal processor or other processor (although not shown) configured to perform various sonar processing. In some embodiments, the processor (e.g., processor(s) 1110 in the marine electronic device 1160, a controller (or processor portion) in the sonar transducer assembly 1162, or a remote controller—or combinations thereof) may be configured to filter sonar return data and/or selectively control sonar transducer element(s) 1167. For example, various processing devices (e.g., a multiplexer, a spectrum analyzer, A-to-D converter, etc.) may be utilized in controlling or filtering sonar return data and/or transmission of sonar signals from the sonar transducer element(s) 1167. The processor(s) 1110 or processor(s) in the sonar transducer assembly 1162 may also be configured to filter data regarding certain objects out of map data.

The sonar transducer assembly 1162 may also include one or more other systems, such as various sensor(s) 1166. For example, the sonar transducer assembly 1162 may include an orientation sensor, such as gyroscope or other orientation sensor (e.g., accelerometer, MEMS, etc.) that can be configured to determine the relative orientation of the sonar transducer assembly 1162 and/or the one or more sonar transducer element(s) 1167, such as with respect to a forward direction of the watercraft. In some embodiments, additionally or alternatively, other types of sensor(s) are contemplated, such as, for example, a water temperature sensor, a current sensor, a light sensor, a wind sensor, a speed sensor, or the like. While only one sonar transducer assembly 1162 is illustrated in FIG. 11, additional sonar transducer assemblies may be provided in other embodiments.

The components presented in FIG. 11 may be rearranged to alter the connections between components. For example, in some embodiments, a marine device outside of the marine electronic device 1160, such as the radar 1156A, may be directly connected to the processor(s) 1110 rather than being connected to the communications interface 1178. Additionally, sensors and devices implemented within the marine electronic device 1160 may be directly connected to the communications interface in some embodiments rather than being directly connected to the processor(s) 1110.

FIG. 12 is a flow chart illustrating an example method 1200 for using an augmented reality device. At operation 1202, a position and a line of sight of the augmented reality device or a wearable frame thereof may be determined. At operation 1204, a live sonar image may be received. At operation 1206, the position and the line of sight of the augmented reality device or the wearable frame thereof are correlated to a corresponding portion of the live sonar image. At operation 1208, presentation of the live sonar image may be caused on at least one portion of the display so that the surrounding environment and the corresponding portion of the live sonar image are both visible in the display from the perspective of a user.

In some embodiments, only operations 1202, 1204, 1206, and 1208 of the method 1200 may be performed. However, in the illustrated embodiment, other operations may also be performed. An identification of a target may be received at operation 1210. The target may be received through a user selection in some embodiments. For example, an augmented reality device may be configured to enable a selection or deselection of the target by a user by detecting a particular hand gesture in a particular direction, a voice command, a particular eye movement, or another head or body movement. However, the target may be received through the use of machine learning, artificial intelligence, and/or algorithm based approaches for automatic identification of objects. A representation of the target may be highlighted in the one or more images at operation 1212. One or more processors may cause the representation of the target to be highlighted. In some embodiments, the target may be a moving target, and the representation of the target may remain highlighted as the target moves through the surrounding environment.

At operation 1214, additional information regarding the target may be presented. This additional information may be a movement speed of the target if the target is moving, a direction vector (e.g., an arrow) for the target if the target is moving, identification information for the target (e.g., bass fish, some other type of underwater animal, etc.) or something else. The additional information may be overlayed on the display so that the additional information is presented alongside the live sonar image and the surrounding environment (or images thereof).

At operation 1216, a position on a water surface may be determined. This position may be a position on the water surface corresponding to a current location or an anticipated location of the target. At operation 1218, a target representation may be overlayed proximate to a corresponding position on the represented water surface in the display. The corresponding position may correspond to the position determined at operation 1216.

At operation 1220, user input may be received. This user input may be a hand gesture, a voice command, an eye movement, a head movement, or some other body movement. At operation 1222, operation of a motor or sonar transducer array may be adjusted based on the user input received at operation 1220. For example, operation of the motor or the sonar transducer array may be adjusted by turning the motor or the sonar transducer array on or off, by changing an orientation of the motor or the sonar transducer array, or by changing a motor speed.

The method 1200 of FIG. 12 is merely exemplary, and the method 1200 may be modified in various ways. For example, certain operations may be omitted or operations may be added. For example, operations 1202, 1204, 1206, 1208 may be the only operations that are performed in some embodiments. Additionally, operations may be performed in different orders, and some of the operations may be performed simultaneously.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed:

1. An augmented reality system for use in a watercraft, the augmented reality system comprising:
an augmented reality device comprising a display configured to allow a user to view a portion of a surrounding environment through the display, wherein the portion of the surrounding environment corresponds to a current viewpoint of the user such that the user would otherwise see the portion of the surrounding environment if the augmented reality device was not present;
one or more processors; and
one or more memory devices comprising computer program code configured, when executed by the one or more processors, to cause the one or more processors to:
determine a position and a line of sight of the augmented reality device;
receive a live sonar image;
correlate the position and the line of sight of the augmented reality device to a corresponding portion of the live sonar image; and
cause presentation of the live sonar image on at least one portion of the display so that the portion of the surrounding environment and the corresponding portion of the live sonar image are both visible in the display from a perspective of the user.

2. The augmented reality system of claim 1, wherein the augmented reality device is at least one of smart glasses or a headset, wherein the display is provided in the form of lenses, wherein causing the live sonar image to be presented on at least one portion of the display of the augmented reality device results in the live sonar image being shown in the lenses in a partially transparent manner so that both the portion of the surrounding environment and the corresponding portion of the live sonar image are visible.

3. The augmented reality system of claim 1, wherein the augmented reality device is a phone, a tablet, a computer, a headset, or a marine electronic device, wherein the augmented reality device comprises a screen and a camera, wherein the display is the screen, wherein the camera is configured to generate one or more images of the portion of the surrounding environment, and wherein the one or more images of the portion of the surrounding environment are presented on the screen alongside the live sonar image so that both the one or more images of the portion of the surrounding environment and the corresponding portion of the live sonar image are visible on the screen.

4. The augmented reality system of claim 1, wherein the computer program code is configured, when executed by the one or more processors, to cause the one or more processors to:
receive an identification of a target; and
cause a representation of the target to be highlighted.

5. The augmented reality system of claim 4, wherein the augmented reality device is configured to enable a selection or deselection of the target by a user by detecting a particular hand gesture in a particular direction, a voice command, a particular eye movement, or another head or body movement.

6. The augmented reality system of claim 4, wherein the target is a moving target, and wherein the representation of the target remains highlighted as the target moves through the surrounding environment.

7. The augmented reality system of claim 6, wherein the moving target is a fish or another underwater animal, and wherein the computer program code is configured, when executed by the one or more processors, to cause the one or more processors to:
overlay at least one of a movement speed or a direction vector for the moving target on the at least one portion of the display of the augmented reality device.

8. The augmented reality system of claim 6, wherein the moving target is a fish or another underwater animal, and wherein the computer program code is configured, when executed by the one or more processors, to cause the one or more processors to:
overlay identification information for the moving target on the at least one portion of the display of the augmented reality device.

9. The augmented reality system of claim 6, wherein the moving target is a fish or another underwater animal, wherein the computer program code is configured, when executed by the one or more processors, to cause the one or more processors to:
determine a position on a water surface corresponding to a current location or an anticipated location for the moving target; and
overlay a target representation proximate to the position on the at least one portion of the display of the augmented reality device.

10. The augmented reality system of claim 1, wherein the computer program code is configured, when executed by the one or more processors, to cause the one or more processors to:
receive a user input that is at least one of a particular hand gesture, a voice command, an eye movement, a head movement, or a body movement; and
adjust operation of a motor or a sonar transducer array based on the user input,
wherein the operation of the motor or the sonar transducer array is adjusted by turning the motor or the sonar transducer array on or off, by changing an orientation of the motor or the sonar transducer array, or by changing a motor speed.

11. The augmented reality system of claim 1, further comprising:
a marine electronic device attached to the watercraft,
wherein the augmented reality device is configured to record a live video feed and send the live video feed to the marine electronic device or to the one or more memory devices.

12. The augmented reality system of claim 1, wherein at least one of a travel path representation, a target location representation, a hazard representation, topographical representations indicating depth information, or a second image are presented on the display, wherein the second image is at least one of a sonar image, a radar image, an underwater image, or a video.

13. The augmented reality system of claim 12, wherein the second image is presented on the display, wherein a particular position is emphasized in both the second image and in the live sonar image.

14. An augmented reality device for use in a watercraft, the augmented reality device comprising:
a display configured to allow the user to view a portion of a surrounding environment through the display, wherein the portion of the surrounding environment corresponds to a current viewpoint such that the user would otherwise see the portion of the surrounding environment if the augmented reality device was not present;
one or more processors; and
one or more memory devices comprising computer program code configured, when executed by the one or more processors, causes the one or more processors to:
determine a position and a line of sight;
receive a live sonar image;
correlate the position and the line of sight to a corresponding portion of the live sonar image; and
cause presentation of the live sonar image on at least one portion of the display so that the portion of the surrounding environment and the corresponding portion of the live sonar image are both visible in the display from a perspective of the user.

15. The augmented reality device of claim 14, wherein the augmented reality device is provided in the form of at least one of smart glasses or a headset, wherein the display is provided in the form of lenses, wherein causing the live sonar image to be presented in the display of the augmented reality device results in the live sonar image being shown in the lenses in a partially transparent manner so that both the portion of the surrounding environment and the corresponding portion of the live sonar image are visible.

16. The augmented reality display of claim 14, wherein the augmented reality device provided in the form of a phone, a tablet, a computer, a headset, or a marine electronic device, wherein the augmented reality device comprises a screen and a camera, wherein the display is the screen, wherein the camera is configured to generate one or more images of the surrounding environment, and wherein the one or more images of the surrounding environment are presented on the screen alongside the live sonar image so that both the one or more images of the surrounding environment and the corresponding portion of the live sonar image are visible on the screen.

17. A method for using an augmented reality device, the method comprising:
determining a position and a line of sight of the augmented reality device;
receiving a live sonar image;
correlating the position and the line of sight of the augmented reality device to a corresponding portion of the live sonar image; and
causing presentation of the live sonar image on at least one portion of the display so that the surrounding environment and the corresponding portion of the live sonar image are both visible in the display from a perspective of the user.

18. The method of claim 17, wherein the augmented reality device is provided in the form of at least one of smart glasses or a headset, wherein the display is provided in the form of lenses, wherein causing the live sonar image to be presented in the display of the augmented reality device results in the live sonar image being shown in the lenses in a partially transparent manner so that both the portion of the surrounding environment and the corresponding portion of the live sonar image are visible.

19. The method of claim 17, wherein the augmented reality device provided in the form of a phone, a tablet, a computer, a headset, or a marine electronic device, wherein the augmented reality device comprises a screen and a camera, wherein the display is the screen, wherein the camera is configured to generate one or more images of the surrounding environment, and wherein the one or more images of the surrounding environment are presented on the screen alongside the live sonar image so that both the one or more images of the surrounding environment and the corresponding portion of the live sonar image are visible on the screen.

20. The method of claim 17, further comprising:
receiving an identification of a target; and
causing a representation of the target to be highlighted.
